(19) United States
(12) Patent Application Publication
(10) Pub. No.: US 2016/0181635 A1
(43) Pub. Date: Jun. 23, 2016

(54) FUEL SUPPLY UNIT

(71) Applicant: AISAN KOGYO KABUSHIKI KAISHA, Obu-shi (JP)

(72) Inventor: Sadatsugu NAGATA, Aichi-gun (JP)

(21) Appl. No.: 14/926,402

(22) Filed: Oct. 29, 2015

(30) Foreign Application Priority Data
Dec. 17, 2014 (JP) 2014-255129

(51) Int. Cl. H01M 8/04082; B05B 1/20

(52) U.S. Cl. CPC H01M 8/04201; B05B 1/20

(57) ABSTRACT

A fuel supply unit includes side-feed injectors each having a side surface formed with a communication port through which fuel is supplied in each injector, and a block body provided with an inflow passage in which the fuel flows, an outflow passage through which the fuel injected from the injectors flows out, fitting holes which are connected to the inflow passage and the outflow passage and in which the respective injectors are fitted. The fitting holes and the injectors are arranged in series in a central axis direction of the inflow passage. The inflow passage is connected to the fitting holes from a radial direction thereof.

### CROSS-REFERENCE TO RELATED APPLICATIONS

This application is based upon and claims the benefit of priority from the prior Japanese Patent Application No. 2014-255129, filed Dec. 17, 2014, the entire contents of which are incorporated herein by reference.

### BACKGROUND OF THE INVENTION

1. Field of the Invention

The present invention relates to a fuel supply unit to be used for adjusting a flow rate and pressure of fuel to be supplied from a fuel container to a destination.

2. Related Art

A fuel injection apparatus disclosed in Patent Document 1 is provided with a plurality of fuel injection valves and a fuel supply passage for supplying fuel to the fuel injection valves in turn. Each of the fuel injection valves is configured to allow fuel to flow in an internal passage through a fuel inflow port formed in a side wall and inject the fuel therefrom, and also allow surplus fuel having not been injected to flow out through a fuel outflow port formed in a side wall. The plurality of fuel injection valves are arranged in series within a fuel supply passage.

### RELATED ART DOCUMENTS

### Patent Documents

Patent document 1: JP-A-63-275868(1988)

### SUMMARY OF INVENTION

### Problems to be Solved by the Invention

However, in the fuel injection apparatus disclosed in Patent Document 1, the fuel supply passage and a fuel discharge passage (not shown) through which the fuel injected from the fuel injection valves is discharged are separately provided. This configuration results in a complicated structure and an increased size of the apparatus. Further, the number of components constituting the apparatus is also large.

The present invention has been made to solve the above problems and has a purpose to provide a fuel supply unit with simplified structure and reduced size.

### Means of Solving the Problems

To achieve the above purpose, one aspect of the invention provides a fuel supply unit comprising: a plurality of side-feed injectors each having a side surface formed with a communication port through which fuel is supplied into the corresponding injector; and a block body provided with an inflow passage in which the fuel flows, an outflow passage through which the fuel injected from the injectors flows out, and a plurality of fitting holes which are connected to the inflow passage and the outflow passage and in which the respective injectors are fitted, wherein the fitting holes and the injectors are arranged in series in a direction of a central axis of the inflow passage, and wherein the inflow passage is connected to the fitting holes from a radial direction of the fitting holes.

According to the above aspect, a side-feed injector is employed so that the inflow passage and the outflow passage are collectively arranged together in the block body. Therefore, the fuel supply unit can be provided with simplified structure and reduced size.

Since the inflow passage is connected to the fitting holes from the radial direction of the fitting holes, furthermore, the block body can be reduced in size. This configuration can reliably achieve downsizing of the fuel supply unit.

### Effect of the Invention

The fuel supply unit according to the present invention can be provided with simplified structure and reduced size.

### BRIEF DESCRIPTION OF THE DRAWINGS

FIG. 1 is a schematic structural diagram of a fuel cell system;

FIG. 2 is an external perspective view of a hydrogen supply unit in Example 1;

FIG. 3 is a sectional view of the hydrogen supply unit in Example 1;

FIG. 4 is a sectional view taken along a line A-A in FIG. 3;

FIG. 5 is an enlarged sectional view of a valve seat and its surrounding parts in an injector in Example 1;

FIG. 6 is a schematic diagram (during valve closing) of the valve seat and its surrounding parts in Example 1;

FIG. 7 is a sectional view of an injector in a first variation of Example 1;

FIG. 8 is a sectional view of a hydrogen supply unit in a second variation of Example 1;

FIG. 9 is a schematic diagram (during valve closing) of the valve seat and its surrounding parts in a third variation of Example 1;

FIG. 10 is a sectional view of a stator core and its surrounding parts in an injector in Example 2;

FIG. 11 is a sectional view of a stator core and its surrounding parts in an injector in a variation of Example 2;

FIG. 12 is a sectional view of a valve element of an injector and a stator core and its surrounding parts in Example 3;

FIG. 13 is a sectional view of a valve element of an injector and a stator core and its surrounding parts in a variation of Example 3;

FIG. 14 is an external perspective view of a hydrogen supply unit in Example 4;and

FIG. 15 is a sectional view of the hydrogen supply unit in Example 4.

### DESCRIPTION OF EMBODIMENTS

### EXAMPLE 1

### (Explanation of Fuel Cell System)

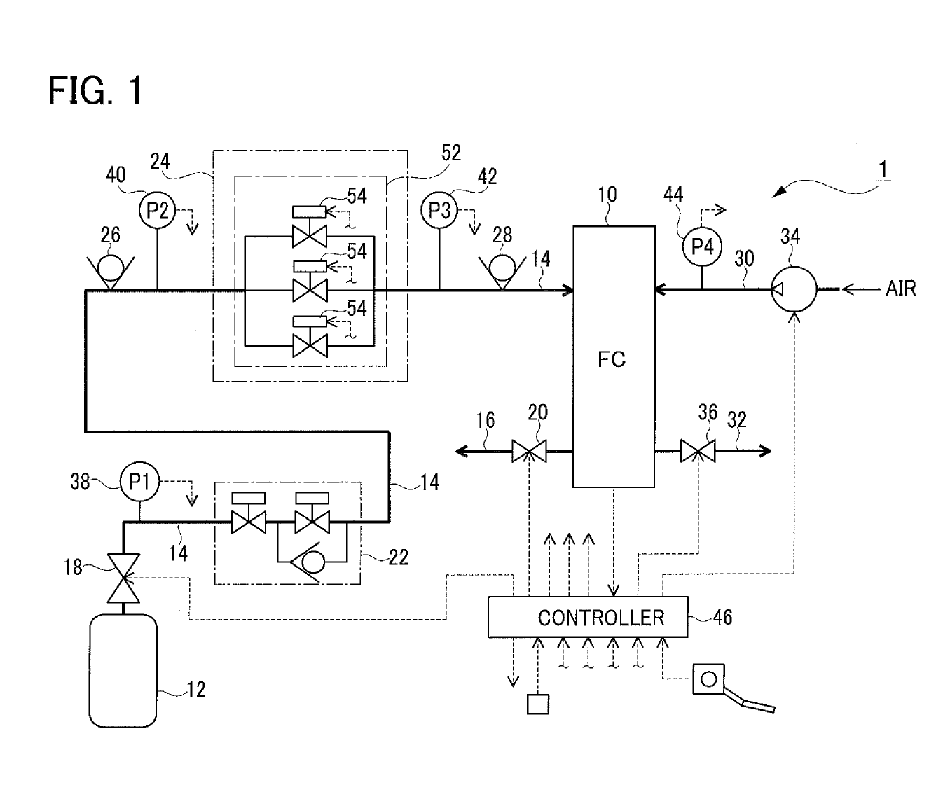

A detailed description of a preferred embodiment of a fuel cell system 1 including a fuel supply unit embodying the present invention will now be given referring to the accompanying drawings. As shown in FIG. 1, the fuel cell system 1 includes a fuel cell (FC) 10, a hydrogen cylinder 12, a hydrogen supply passage 14, a hydrogen discharge passage 16, a main stop valve 18, a first changeover valve 20, a high-pressure regulator 22, a hydrogen supply unit 24, a medium-pressure relief valve 26, a low-pressure relief valve 28, an air supply passage 30, an air discharge passage 32, an air pump 34, a second changeover valve 36, a primary-pressure sensor 38, a secondary-pressure sensor 40, a tertiary-pressure sensor 42, an air-pressure sensor 44, a controller 46, and others.

This fuel cell system 1 is mounted in an electric vehicle and used to supply electric power to a drive motor (not shown) for the vehicle. The fuel cell 10 generates electricity upon receipt of hydrogen gas as fuel gas and air as oxidant gas. The electricity generated in the fuel cell 10 is supplied to the drive motor (not shown) through an inverter (not shown). The hydrogen cylinder 12 stores high-pressure hydrogen gas. The hydrogen gas (fuel gas) is one example of “fuel” in the present invention.

On an anode side of the fuel cell 10, a hydrogen supply system is provided.

This system includes a hydrogen supply passage 14 for supplying hydrogen gas from the hydrogen cylinder 12 to a supply destination, i.e., the fuel cell 10, and a hydrogen discharge passage 16 for discharging hydrogen off-gas allowed to flow out of the fuel cell 10. In the hydrogen supply passage 14 immediately downstream of the hydrogen cylinder 12, the main stop valve 18 is placed, which consists of an electromagnetic valve configured to switch between supplying and shutoff of hydrogen gas from the hydrogen cylinder 12 to the hydrogen supply passage 14. In the hydrogen discharge passage 16, the first changeover valve 20 consisting of an electromagnetic valve is provided.

In the hydrogen supply passage 14 downstream of the main stop valve 18, the high-pressure regulator 22 is provided to reduce the pressure of hydrogen gas. In the hydrogen supply passage 14 between the main stop valve 18 and the high-pressure regulator 22, the primary pressure sensor 38 is provided to detect the internal pressure of the passage 14 as primary pressure P1.

In the hydrogen supply passage 14 downstream of the high-pressure regulator 22, the hydrogen supply unit 24 is provided to adjust the flow rate and the pressure of hydrogen gas to be supplied to the fuel cell 10. The hydrogen supply unit 24 is one example of a fuel supply unit of the present invention. The details of the hydrogen supply unit 24 will be explained later.

The medium-pressure relief valve 26 is placed in the hydrogen supply passage 14 between the high-pressure regulator 22 and the hydrogen supply unit 24. The low-pressure relief valve 28 is placed in the hydrogen supply passage 14 between the hydrogen supply unit 24 and the fuel cell 10. The medium-pressure relief valve 26 and the low-pressure relief valve 28 are each configured to open for pressure release when the internal pressure of the hydrogen supply passage 14 increases to a predetermined value or more.

The secondary-pressure sensor 40 is placed in the hydrogen supply passage 14 between the high-pressure regulator 22 and the hydrogen supply unit 24. This secondary-pressure sensor 40 detects the internal pressure of the hydrogen supply passage 14 as secondary pressure P2 corresponding to medium pressure. The tertiary-pressure sensor 42 is placed in the hydrogen supply passage 14 between the hydrogen supply unit 24 and the fuel cell 10. This tertiary-pressure sensor 42 detects the internal pressure of the hydrogen supply passage 14 as third-order pressure P3 corresponding to low pressure.

On the other hand, on a cathode side of the fuel cell 10, there are provided an air supply passage 30 for supplying air to the fuel cell 10 and an air discharge passage 32 for discharging out air off-gas allowed to flow out. In the air supply passage 30, an air pump 34 is provided to adjust a flow rate of air to be supplied to the fuel cell 10. In the air supply passage 30 downstream of the air pump 34, an air pressure sensor 44 is provided to detect air pressure P4. A second changeover valve 36 constituting an electromagnetic valve is provided in the air discharge passage 32.

In the foregoing structure, the hydrogen gas delivered from the hydrogen cylinder 12 passes through the hydrogen supply passage 14 and then is supplied to the fuel cell 10 via the main stop valve 18, the high-pressure regulator 22, and the hydrogen supply unit 24. The hydrogen gas supplied to the fuel cell 10 is used for generation of electricity in the fuel cell 10, and thereafter discharged as hydrogen off-gas from the cell 10 via the hydrogen discharge passage 16 and the first changeover valve 20.

In the foregoing structure, furthermore, the air discharged into the air supply passage 30 by the air pump 34 is supplied to the fuel cell 10. The air supplied to the fuel cell 10 is used for generation of electricity in the cell 10, and thereafter discharged as air off-gas from the cell 10 via the air discharge passage 32 and the second changeover valve 36.

This fuel cell system 1 is further provided with a controller 46 responsible for control of the system. To control a flow of hydrogen gas to be supplied to the fuel cell 10, the controller 46 controls the main stop valve 18 and injectors 54 of the hydrogen supply unit 24 based on detection values of the primary pressure sensor 38, the secondary pressure sensor 40, and the tertiary pressure sensor 42. The controller 46 further controls the first changeover valve 20 to control a flow of hydrogen off-gas in the hydrogen discharge passage 16.

On the other hand, the controller 46 controls the air pump 34 based on a detection value of the air pressure sensor 44 to control a flow of air to be supplied to the fuel cell 10. The controller 46 also controls the second changeover valve 36 to control a flow of air off-gas in the air discharge passage 32. The controller 46 receives a voltage value and a current value resulting from generation of electricity in the fuel cell 10. The controller 46 includes a central processing unit (CPU) and a memory and thus controls each injector 54, the air pump 34, and others based on a predetermined control program stored in the memory in order to control an amount of hydrogen gas and an amount of air to be supplied to the fuel cell 10.

(Explanation of Hydrogen supply unit)

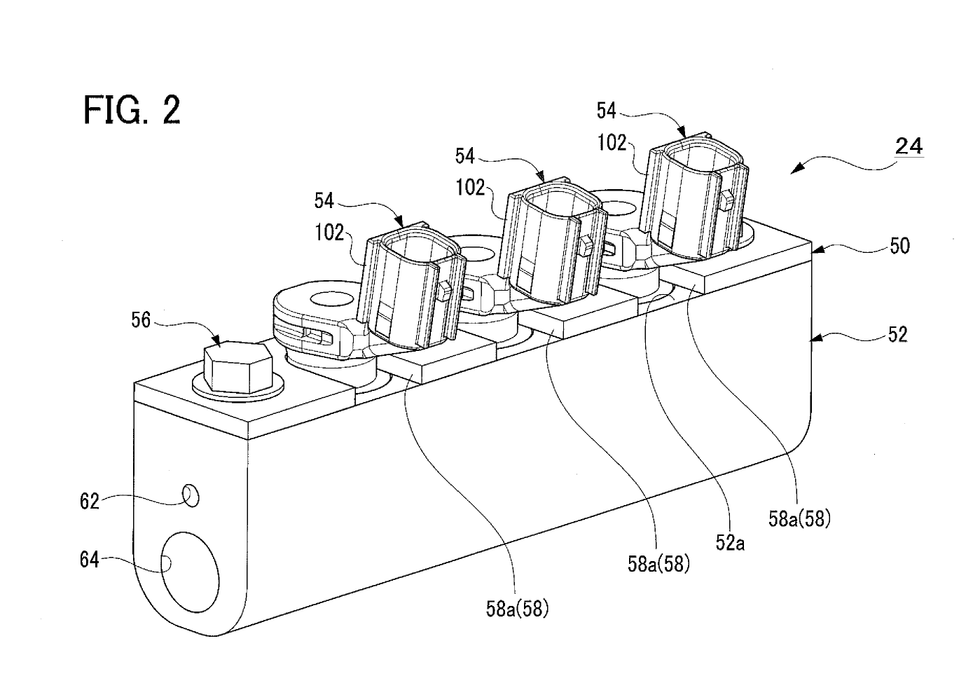

Next, the hydrogen supply unit 24 will be explained below. This hydrogen supply unit 24 includes, as shown in FIGS. 2 to 5, a plate 50, a block body 52, the injectors 54, bolts 56, and others. The plate 50 is one example of a “lid member” of the present invention. The bolts 56 are one example of a “fastening member” of the present invention.

The plate 50 has a flat-plate shape and is provided with cutouts 58, bolt holes 60, and others. Each of the cutouts 58 has an inner peripheral surface 58a in a U-like shape in planer view. A housing 92 of each injector 54 is inserted in the corresponding cutout 58. The bolts 56 are inserted one in each of the bolt holes 60.

The block body 52 is a member for distributing hydrogen gas of the hydrogen supply passage 14 to the injectors 54 and allow streams of hydrogen gas injected from the injectors 54 to merge into one stream. This block body 52 is provided with an inflow passage 62, an outflow passage 64, fitting holes 66, female screw holes 68, and others.

The inflow passage 62 is a passage in which hydrogen gas having flowed through the hydrogen supply passage 14 is allowed to flow. The inflow passage 62 is connected to the fitting holes 66 from the radial direction of each fitting hole 66.

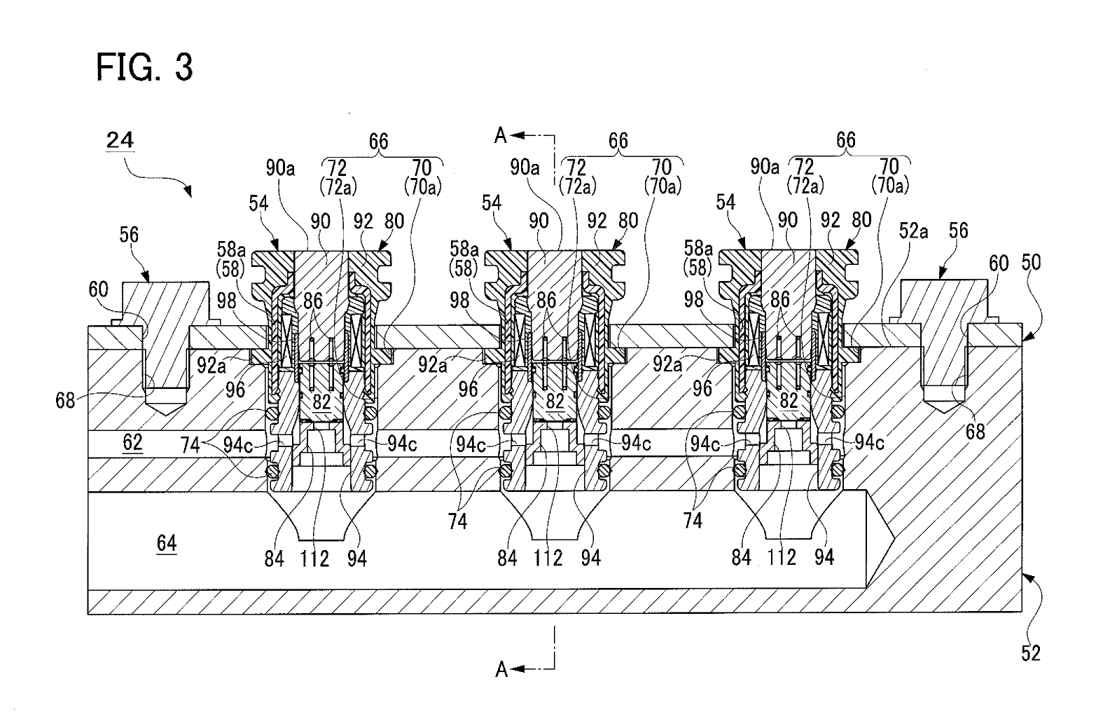

Specifically, the inflow passage 62 is connected to an inner peripheral surface of each fitting hole 66 (concretely, an inner peripheral surface 72a of each of fitting portions 72) and communicates with the inside of the fitting holes 66. In other words, the inflow passage 62 is formed with its central axis (in a right-left direction in FIG. 3) extending perpendicular to a central axis (an up-down direction in FIG. 3) of each fitting hole 66 so that the inflow passage 62 is connected to a side surface of each fitting hole 66, not to an upper side or a lower side of each fitting hole 66. This inflow passage 62 is one passage formed from outside of the block body 52 so as to extend radially across the fitting holes 66.

The outflow passage 64 is a passage through which hydrogen gas injected from the injectors 54 flows out of the fuel supply unit 24. The outflow passage 64 is formed with its central axis (in the right-left direction in FIG. 3) extending perpendicular to the central axis of each fitting hole 66. The outflow passage 64 is one passage formed from outside of the block body 52 so as to radially extend across the fitting holes 66.

The fitting holes 66 are formed to extend from a surface 52a of the block body 52 mating with the plate 50 to the outflow passage 64. The fitting holes 66 are connected to both the inflow passage 62 and the outflow passage 64. In the fitting holes 66, the respective injectors 54 are fitted.

In this example, the fitting holes 66 are formed in three places in the block body 52. Thus, three sets of the fitting holes 66 and the injectors 54 are arranged in series in the central axis direction of the inflow passage 62 so that the central axis of each fitting hole 66 and the central axis of each injector 54 (the up-down direction in FIG. 3) are perpendicular to the central axis of the inflow passage 62.

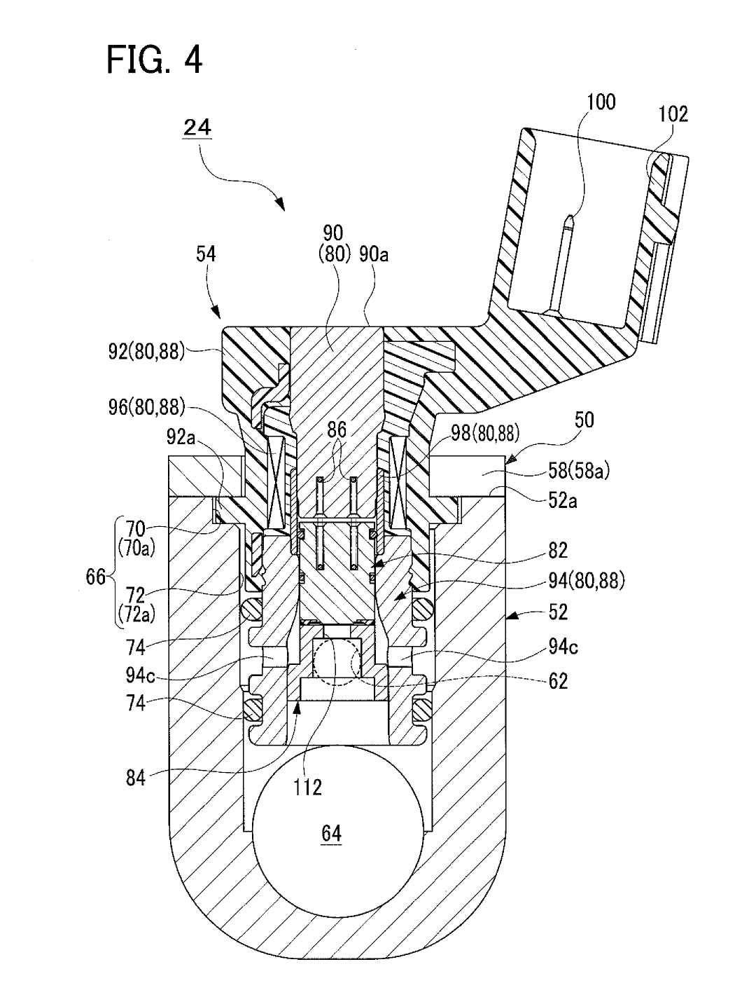

To be concrete, as shown in FIG. 4, each fitting hole 66 includes a large-diameter portion 70 and a fitting portion 72 in the order from the surface 52a side of the block body 52. An inner peripheral surface 70a of the large-diameter portion 70 and an inner peripheral surface 72a of the fitting portion 72 each have a nearly circular cylindrical shape. The diameter of the large-diameter portion 70 is larger than the diameter of the fitting portion 72. The large-diameter portion 70 is formed at an exit of the fitting hole 66 on the surface 52a side. In this large-diameter portion 70, a protruding portion 92a of the housing 92 of the injector 54 is fitted. In the fitting portion 72, a casing 94 of the injector 54 is set with two O-rings 74 attached on the outer peripheral surface. To be concrete, in the fitting portion 72, one of the 0-rings 74 is placed between a connected portion to the large-diameter portion 70 and a connected portion to the inflow passage 62, and the other O-ring 74 is placed between a connected portion to the inflow passage 62 and a connected portion to the outflow passage 64.

The bolts 56 are tightened in the respective female screw holes 68. Thus, the plate 50 is fastened to the block body 52 with those bolts 56.

The injectors 54 are held by the block body 52 and the single plate 50 through the protruding portions 92a sandwiched therebetween. The injectors 54 are connected to the inflow passage 62 and the outflow passage 64 to adjust a flow rate and a pressure of hydrogen gas. In this example, the hydrogen supply unit 24 includes three injectors 54. The number of injectors 54 and the number of fitting holes 66 are not particularly limited to three and may be one, two, or four or more. The details of the injectors 54 will be mentioned later.

The hydrogen supply unit 24 configured as above is operative to inject hydrogen gas flowing in the inflow passage 62 into the outflow passage 64 through the injectors 54, thereby reducing the pressure of hydrogen gas.

### (Explanation of Injectors)

The injectors 54 (the fuel injection apparatus) will be described below.

The injectors 54 in this example are so-called side-feed injectors each of which includes the casing 94 constituting the side surface, or the peripheral surface, of the injector 54 and being formed with communication ports 94c through which hydrogen gas is to be supplied into the corresponding injector 54.

Each of the injectors 54 includes a main unit 80, a valve element 82, a valve seat 84, a compression spring 86, and others as shown in FIGS. 2 to 5.

The main unit 80 is provided with a casing body 88 and a stator core 90. The casing body 88 includes a housing 92, the casing 94, an electromagnetic coil 96, a non-magnetic bush 98, and others. This casing body 88 accommodates therein the valve element 82, the valve seat 84, the compression spring 86, the stator core 90.

The housing 92 is configured to surround a part of the stator core 90, the non-magnetic bush 98, and a part of the casing 94. The housing 92 is made of resin and has the electromagnetic coil 96 embedded therein. The electromagnetic coil 96 is placed in a position surrounding the stator core 90. The housing 92 is provided with a connector part 102 provided with a plurality of terminal pins 100. These terminal pins 100 are electrically connected to the electromagnetic coil 96. The connector part 102 can be connected to an external power source (not shown) through a wire harness (not shown) and an external control unit (the controller 46).

The stator core 90 has a nearly columnar shape (including a perfect-circular columnar shape, an elliptic columnar shape, etc.). The stator core 90 is placed in a position opposite the valve seat 84 with respect to the valve element 82. In this example, the stator core 90 is not formed with any passage for hydrogen gas. An end portion (a lower end portion in FIG. 3) of the stator core 90 on a side close to the valve element 82 is inserted in an upper end of a through hole of the non-magnetic bush 98 having a nearly cylindrical shape. The stator core 90 and the non-magnetic bush 98 are welded to each other over their entire circumference. The non-magnetic bush 98 is made of non-magnetic material.

The casing 94 has a nearly cylindrical shape having a through hole 94a formed in the center (inside the inner peripheral surface 94b). The casing 94 and the non-magnetic bush 98 are welded to each other over their entire circumference so that the through hole 94a of the casing 94 and a through hole of the non-magnetic bush 98 are hermetically connected to each other. The casing 94 is made of soft magnetic material (e.g., electromagnetic stainless steel). The casing 94 accommodates the valve element 82 and the valve seat 84 in the through hole 94a. The through hole 94a communicates with the inflow passage 62 through the communication ports 94c and the fitting hole 66.

In this example, the casing 94 is provided with the communication ports 94c. Each communication port 94c communicates with the through hole 94a and the fitting hole 66 and further communicates with the inflow passage 62 through the fitting hole 66. In this example, the communication ports 94c are formed in four places, but the number of communication ports 94c is not limited to four and may be two, three, or five or more.

The valve element 82 is placed in a position on a side close to the stator core 90 (an upper side in FIG. 3) relative to the valve seat 84 in the through hole 94a of the casing 94. The valve element 82 is made of soft magnetic material (e.g., electromagnetic stainless steel). This valve element 82 is positioned with its upper end is located in the through hole of the non-magnetic bush 98.

The valve element 82 has a nearly columnar shape. In this example, the valve element 82 is not formed with any passage for hydrogen gas. The valve element 82 is provided with a seat sealing member 104 placed on a lower end face 82b (an end face on a side close to the valve seat 84). The seat sealing member 104 is made of rubber, resin, or the like. The seat sealing member 104 is provided with a contact portion 104a which makes contact with the valve seat 84 during valve closing in which the valve element 82 is held in contact with the valve seat 84.

The valve seat 84 has a nearly cylindrical shape and includes a small-diameter portion 106 and a large-diameter portion 108. The diameter of the small-diameter portion 106 is smaller than the diameter of the large-diameter portion 108. The small-diameter portion 106 is placed on a side closer to the valve element 82 than the large-diameter portion 108. The seat portion 110 of the small-diameter portion 106 is formed with an injection port 112. The small-diameter portion 106 is provided with a seat surface 84a on a side close to the valve element 82.

The valve seat 84 and the casing 94 are hermetically held by one of the following ways: (a) press-fitting the large-diameter portion 108 of the valve seat 84 into the casing 94; (b) welding an outer peripheral surface 84b of the valve seat 84 and the casing 94 to each other over their entire circumference; and (c) making both press-fitting and welding.

The compression spring 86 is placed in the valve element 82 and the stator core 90. An upstream end of the compression spring 86 is set in contact with the stator core 90, while a downstream end of the same is set in contact with the valve element 82. The compression spring 86 is held in a compressed state, urging the valve element 82 toward the valve seat 84. Specifically, the valve element 82 is urged in a direction toward the valve seat 84 (in an opposite direction to the stator core 90) by the compression spring 86.

O-rings 114 are fitted between the outer peripheral surface 82c of the valve element 82 and a nearly cylindrical inner peripheral surface of the casing body 88, that is, between the outer peripheral surface 82c of the valve element 82 and the inner peripheral surface 94b of the casing 94, and between the outer peripheral surface 82c of the valve element 82 and the inner peripheral surface 98a of the non-magnetic bush 98.

Specifically each of the injectors 54 is provided with two O-rings 114. These O-rings 114 are one example of a “sealing member” of the present invention.

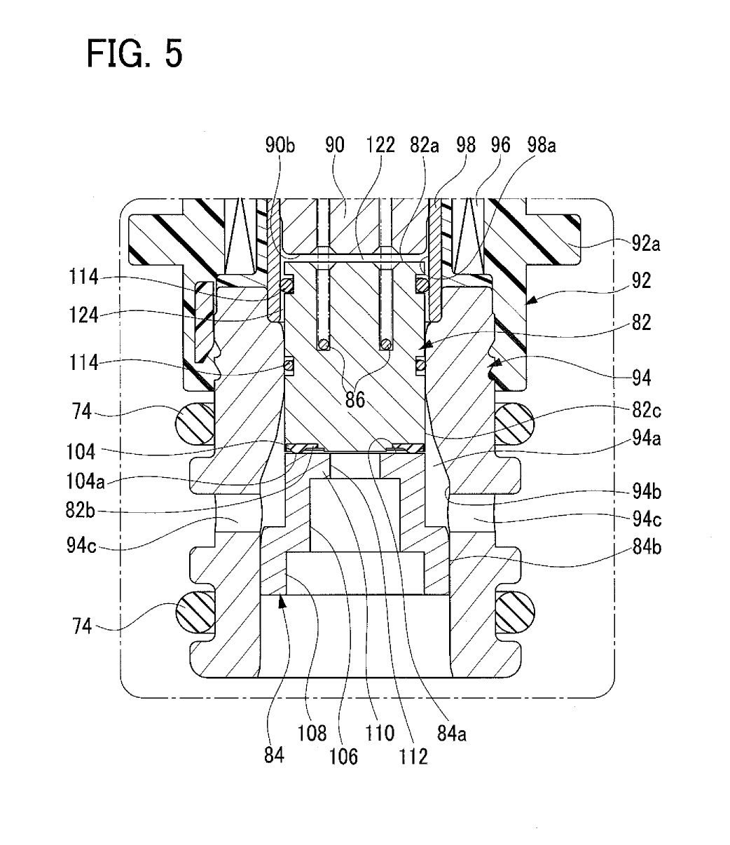

Next, operations (actions) of the injectors 54 will be explained below. In each injector 54, firstly, while no electric power is applied to the electromagnetic coil 96 through the terminal pins 100 of the connector part 102, that is, during valve closing, the valve element 82 is held in contact with the seat surface 84a of the valve seat 84 by urging force of the compression spring 86 as shown in FIG. 5. Concretely, the seat sealing member 104 is pressed against the seat surface 84a. Therefore, the injection port 112 of the valve seat 84 is shut off, or disconnected, from the through hole 94a of the casing 94. This state blocks the hydrogen gas from flowing out through the injection port 112 to the outside of the injector 54.

On the other hand, while electric power is applied to the electromagnetic coil 96 through the terminal pins 100 of the connector part 102, that is, during valve opening, the electromagnetic coil 96 generates a magnetic field, thereby exciting the valve element 82 and the stator core 90. Then, the valve element 82 and the stator core 90 attract each other and thus the valve element 82 is moved toward the stator core 90. Specifically, the valve element 82 separates from the seat surface 84a of the valve seat 84. Thus, the injection port 112 of the valve seat 84 becomes communicated with the inflow passage 62 through a gap or space generated between the seat sealing member 104 of the valve element 82 and the seat surface 84a, the through hole 94a and the communication port 94c of the casing 94. This allows hydrogen gas flowing in the inflow passage 62 to flow in the injection port 112. Accordingly, hydrogen gas is released from the injection port 112 into the outflow passage 64 outside of the injector 54.

According to this example, as explained above, the hydrogen supply unit 24 includes the side-feed injectors 54, and the block body 52 provided with the inflow passage 62, the outflow passage 64, and the fitting holes 66.

As above, the hydrogen supply unit 24 includes the side-feed injectors 54 and is configured such that the inflow passage 62 and the outflow passage 64 are collectively arranged together in the single block body 52. Therefore, the hydrogen supply unit 24 is reduced in the number of components and also reduced in volume. This can achieve a simplified structure and a reduced size of the hydrogen supply unit 24.

The fitting holes 66 are formed in more than one place in the block body 52. The plurality of sets of fitting holes 66 and plurality of injectors 54 are arranged in series in the central axis direction of the inflow passage 62. The inflow passage 62 is connected to each fitting hole 66 from the radial direction thereof. Specifically, the inflow passage 62 is connected to the side surface of each fitting hole 66, not to an upper side or a lower side of each fitting hole 66. Thus, the block body 52 can be reduced in size. This can reliably achieve the reduced size of the hydrogen supply unit 24.

The injectors 54 are held by the block body 52 and the single plate 50 through the protruding portions 92a sandwiched therebetween. Accordingly, the injectors 54 are collectively held by the single plate 50, not by separate plates, so that the number of components forming the hydrogen supply unit 24 can be further reduced.

The plate 50 has a flat-plate shape and is fastened to the block body 52 with the bolts 56. In this example, herein, the inflow passage 62 and the outflow passage 64 are collectively arranged together in the block body 52 as described above. Accordingly, the plate 50 does not need to have the inflow passage 62 and has only to function to hold the injectors 54. Thus, the shape of the plate 50 can be simplified as a flat-plate form. This can further simplify the structure of and reduce the size of the hydrogen supply unit 24.

Each of the inflow passage 62 and the outflow passage 64 is one passage formed from outside of the block body 52 as to extend radially across the fitting holes 66.

Accordingly, the inflow passage 62 and the outflow passage 64 can be formed in the block body 52 by for example one machining work using a cutting tool such as a drill. Consequently, the inflow passage 62 and the outflow passage 64 can be formed easily.

In each of the injectors 54, the valve element 82 is urged by the compression spring 86 toward the valve seat 84. During valve closing, therefore, sealing property between the valve element 82 and the valve seat 84 is ensured with respect to hydrogen gas.

The valve element 82 and the stator core 90 are not formed with any passage for hydrogen gas. During valve opening, therefore, when the upper end face 82a of the valve element 82 (the end face on the side close to the stator core 90) makes contact with the lower end face 90b of the stator core 90 (the end face on the side close to the valve element 82), the upper end face 82a and the lower end face 90b can contact with each other through a large contact area. This enables mitigating impact caused when the valve element 82 comes into contact with the stator core 90, resulting in reduced noise. When the valve element 82 and the stator core 90 are excited, the attraction force between the valve element 82 and the stator core 90 is increased, so that response property of the valve opening motion of the valve element 82 can be enhanced. For example, the valve opening speed of the valve element 82 can be improved.

Each of the injectors 54 is provided with the O-rings 114 (the sealing members) placed between the outer peripheral surface 82c of the valve element 82 and the inner peripheral surface of the casing body 88. Accordingly, the hydrogen gas in the through hole 94a of the casing 94 does not leak into the hermetically closed space portion 122 formed between the upper end face 82a of the valve element 82 and the lower end face 90b of the stator core 90. Therefore, the fuel pressure (the pressure of hydrogen gas) does not act on the upper end face 82a of the valve element 82. Thus, the force (the driving force) for driving the valve element 82 during valve opening can be reduced.

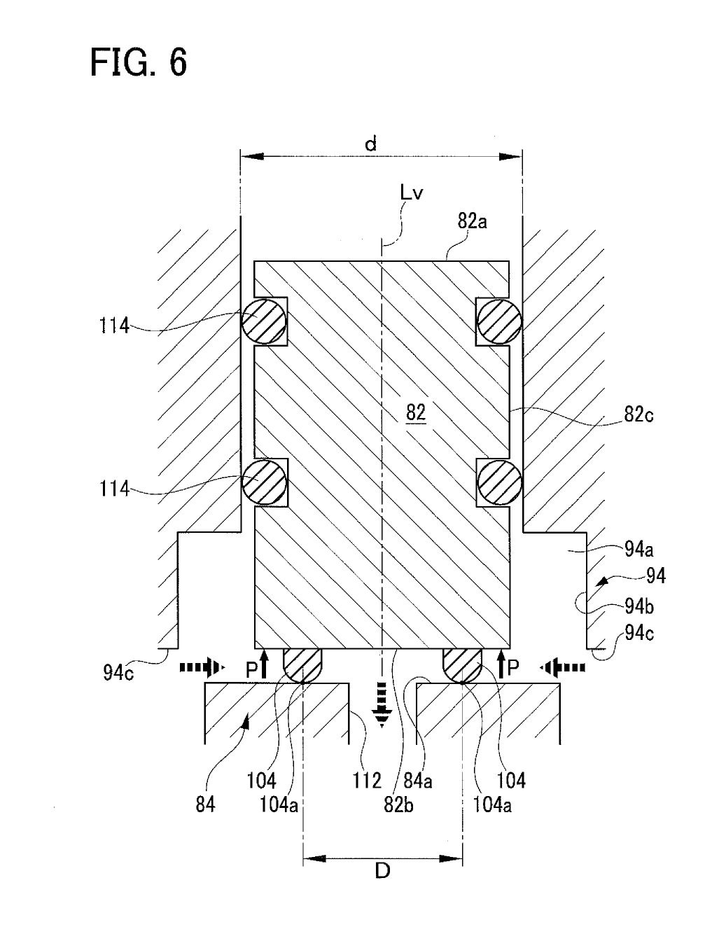

Further, the valve element 82 is provided with the seat sealing member 104 on the lower end face 82b. The seat sealing member 104 is provided with the contact portion 104a which contacts with the valve seat 84 during valve closing. The O-rings 114 and the contact portion 104a are each formed in an annular shape centered at the central axis Lv of the valve element 82. As shown in FIG. 6, the seat sealing diameter D corresponding to the diameter of the contact portion 104a is smaller than the diameter d of each O-ring 114 (the diameter of an outermost portion of each O-ring 114, i.e., the outer diameter of each O-ring 114).

Accordingly, for example, the fuel pressure P acting on the lower end face 82b of the valve element 82 acts in a direction to move the valve element 82 away from the valve seat 84 (in a valve opening direction). This fuel pressure P will assist driving of the valve element 82 during valve opening, so that the driving force required to separate the valve element 82 from the valve seat 84 can be reduced. This can achieve a reduced size of a drive unit (such as the electromagnetic coil 96) for the valve element 82 and hence a reduced size of each injector 54. FIG. 6 is a schematic diagram for explanation. In FIG. 6, dashed arrows indicate flowing directions of hydrogen gas.

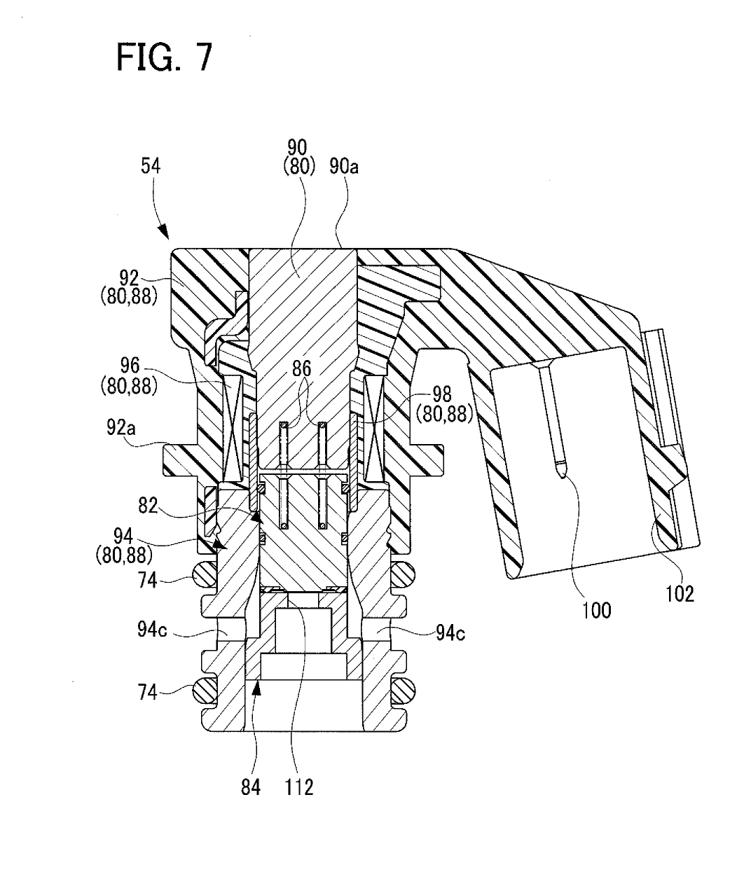

As a first variation, the injectors 54 may be designed so that the respective connector parts 102 are oriented in a reversed direction as shown in FIG. 7. Specifically, an opening of each connector part 102 is directed downward (toward the block body 52). Thus, the height of the hydrogen supply unit 24 can be reduced.

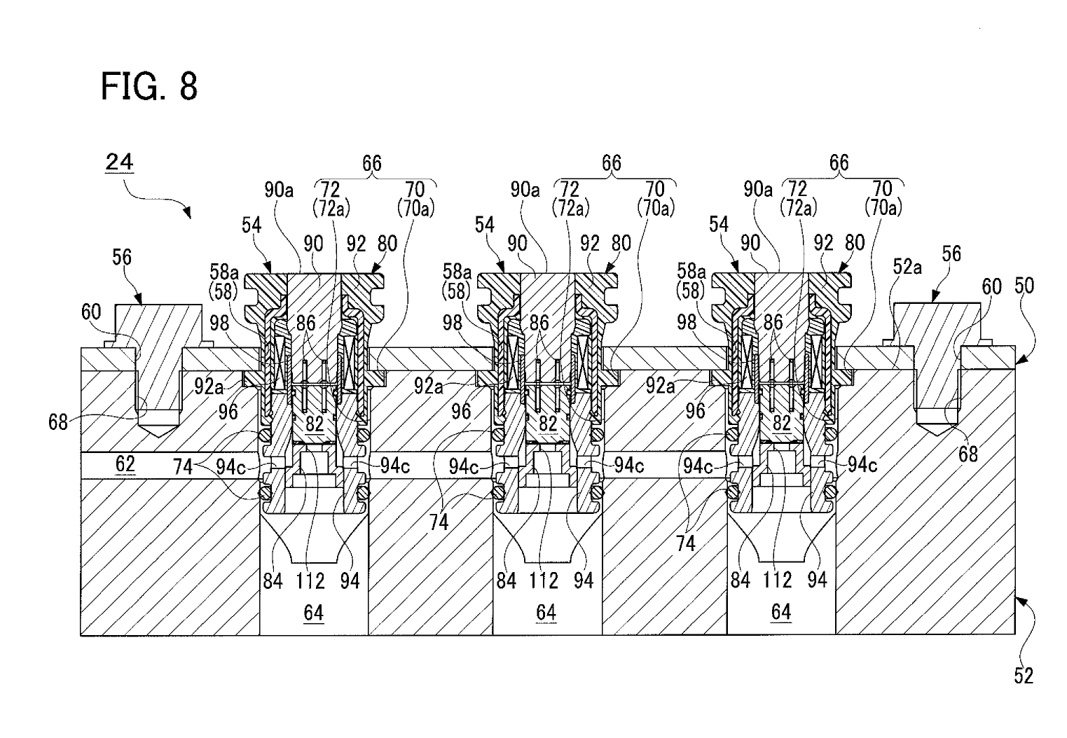

As a second variation, as shown in FIG. 8, the outflow passage 64 may be formed for each injector 54.

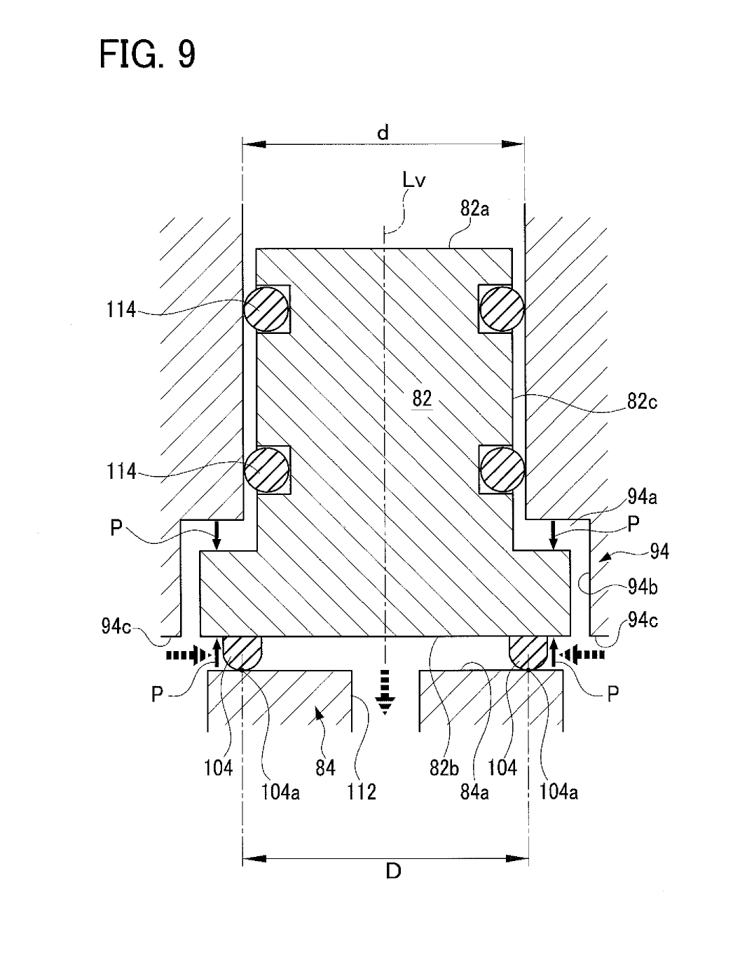

As a third variation, as shown in FIG. 9, the shape of the valve element 82 may be modified so that the seat sealing diameter D is equal to the diameter d of each O-ring 114. Accordingly, the fuel pressures P acting on the valve element 82 are canceled out. During valve opening, therefore, the driving force required to separate the valve element 82 from the valve seat 84 can be reduced. This can reduce the size of the drive unit (such as the electromagnetic coil 96) of the valve element 82 and hence can reduce the size of each injector 54. FIG. 9 is a schematic diagram for explanation. In FIG. 9, dashed arrows indicate flowing directions of hydrogen gas.

Next, Examples 2 to 4 will be explained, in which similar or identical parts to those in Example 1 and between different examples are assigned the same reference signs and their explanations are omitted. The following examples will thus be given with a focus on differences from each other.

### EXAMPLE 2

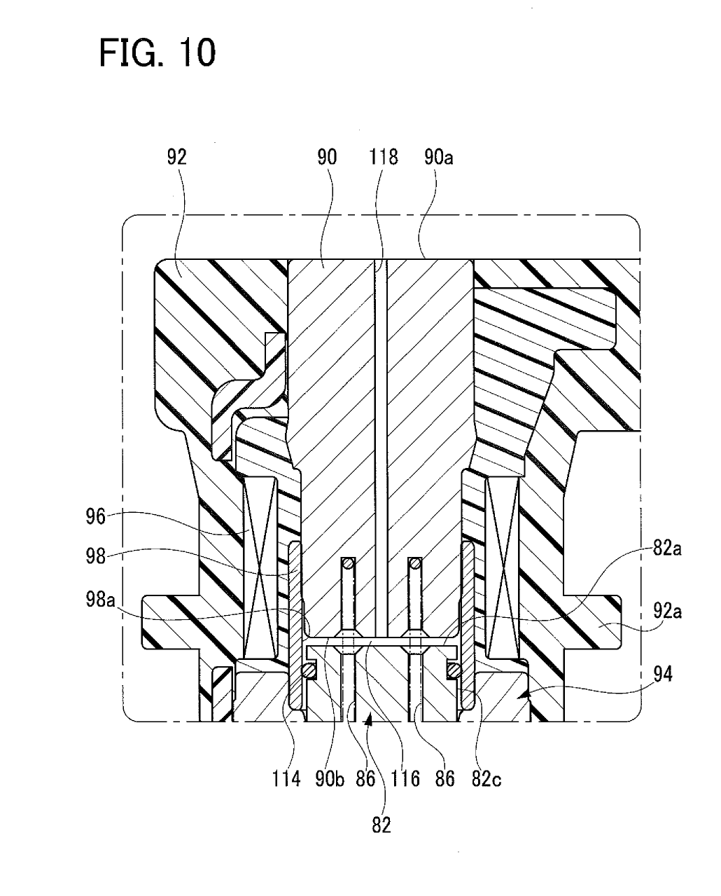

In this example, each injector 54 is provided with a space part 116 defined by the valve element 82, the stator core 90, and the casing body 88 as shown in FIG. 10. The stator core 90 is formed with an atmosphere open passage 118 (a communication passage) communicating with the space part 116 and the outside of the corresponding injector 54.

Accordingly, a pressure rise in the space part 116 can be suppressed. In other words, for example, even if hydrogen gas in the through hole 94a of the casing 94 gradually leaks into the space part 116 through the O-rings 114, the hydrogen gas is allowed to escape to the outside of the injector 54 through the atmosphere open passage 118, so that the pressure rise in the space part 116 can be suppressed. This can prevent an increase in driving force required to separate the valve element 82 from the valve seat 84.

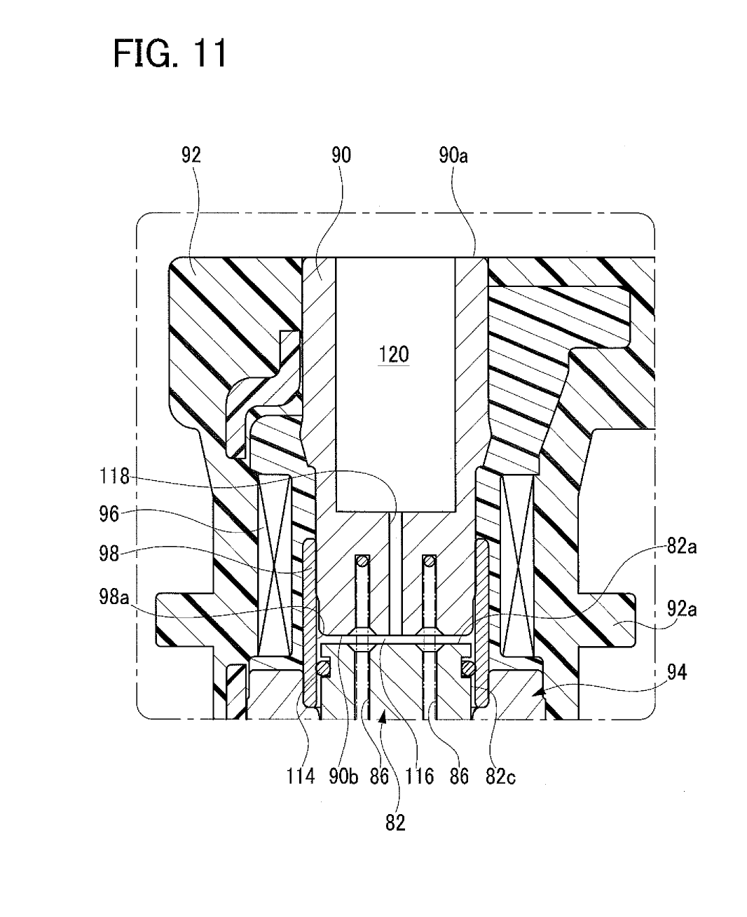

As a variation of this example, the stator core 90 may be provided with a cutout portion 120 formed as a countersink part as shown in FIG. 11. This configuration can achieve weight saving of the injectors 54 and hence the hydrogen supply unit 24. The cutout portion 120 may be a cavity part (a hollow part) in the stator core 90.

### EXAMPLE 3

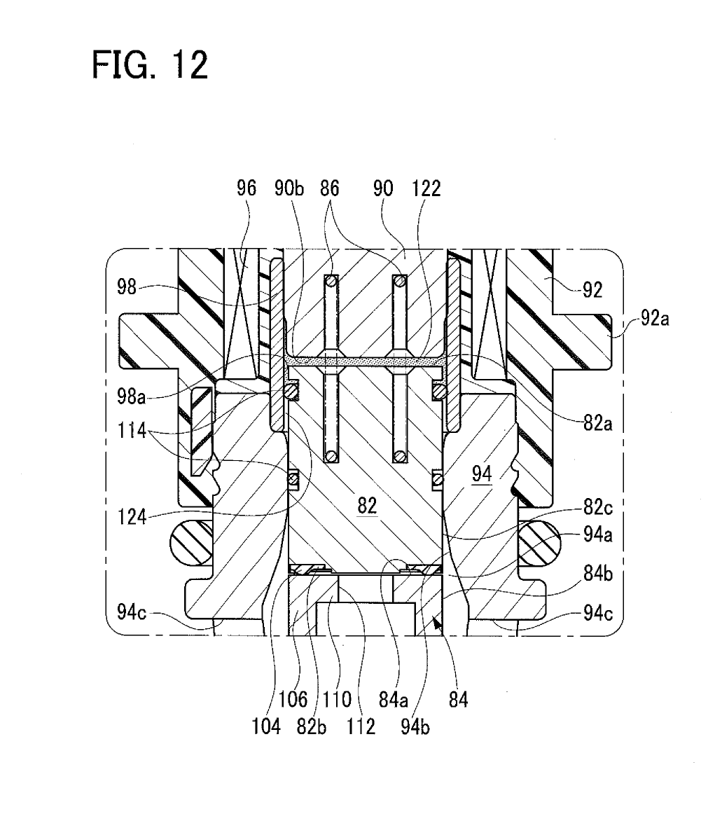

In this example, each of the injectors 54 is provided, as shown in FIG. 12, with a hermetically enclosed space part 122 defined by the valve element 82, the stator core 90, and the casing body 88. In this enclosed space part 122, gas (e.g., the same gas as fuel), liquid (e.g., oil), or an elastic member (e.g., rubber, spring, etc.) is placed. This configuration can reduce or absorb the impact caused between the valve element 82 and the stator core 90 during driving of the valve element 82, thus resulting in reduced noise. Further, the reliability of driving of the valve element 82 can also be enhanced.

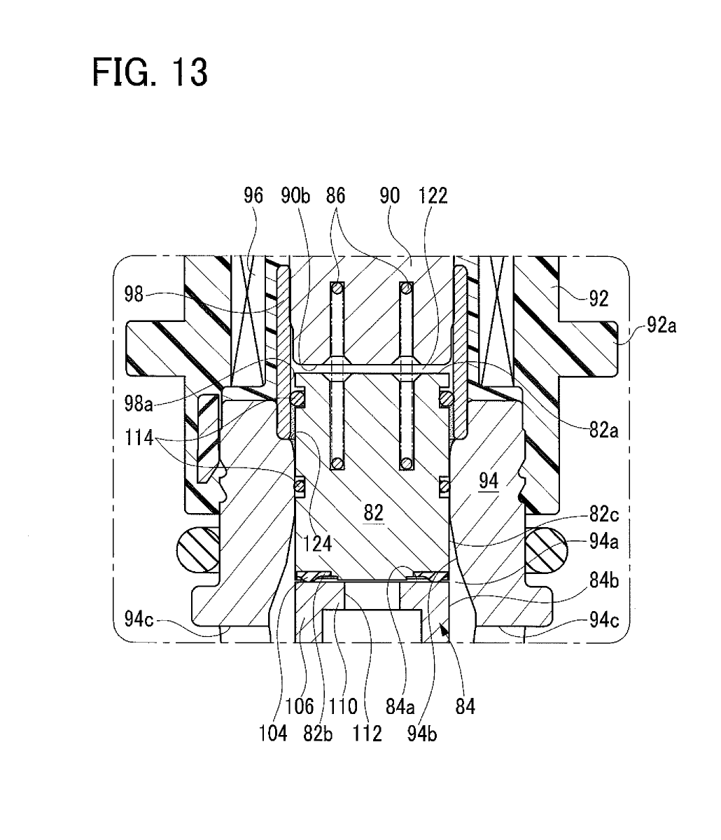

As a variation, as shown in FIG. 13, two O-rings 114 are arranged to generate an O-ring space part 124 as a space area therebetween and such a material (e.g., oil, grease, and so on) as to enhance sliding property of the valve element 82 with respect to the inner peripheral surface of the casing body 88 may be enclosed. This can further reduce the driving force for the valve element 82 and also enhance the reliability of driving of the valve element 82. It is to be noted that one of gas, liquid, and an elastic member may be placed in the enclosed space part 122 and also such a material as to enhance the sliding property of the valve element 82 with respect to the inner peripheral surface of the casing body 88 may be enclosed in the O-ring space part 124.

### EXAMPLE 4

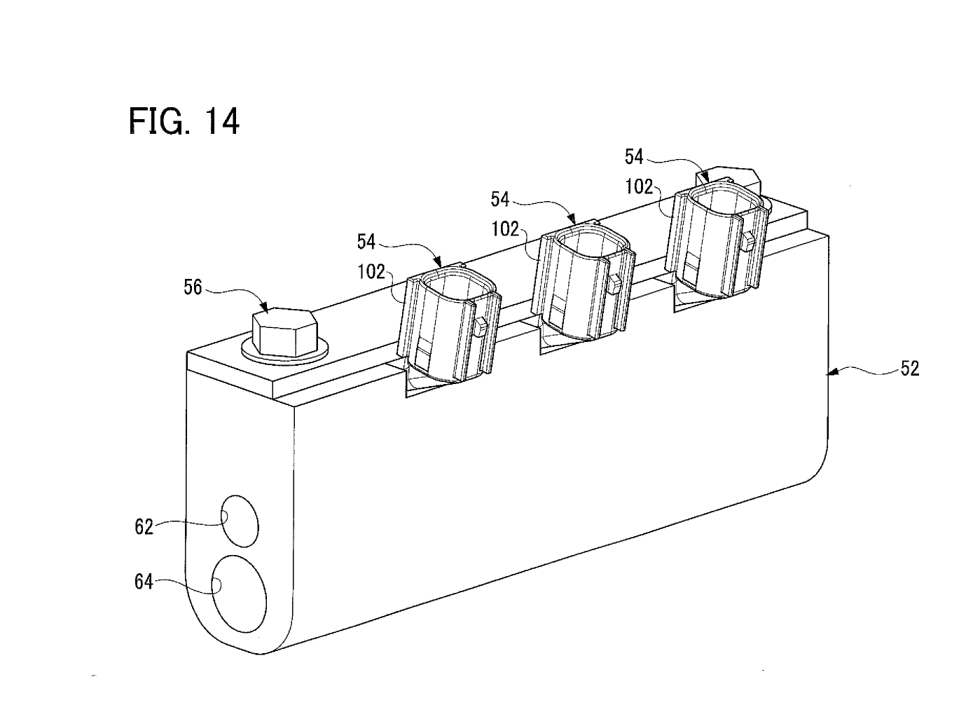

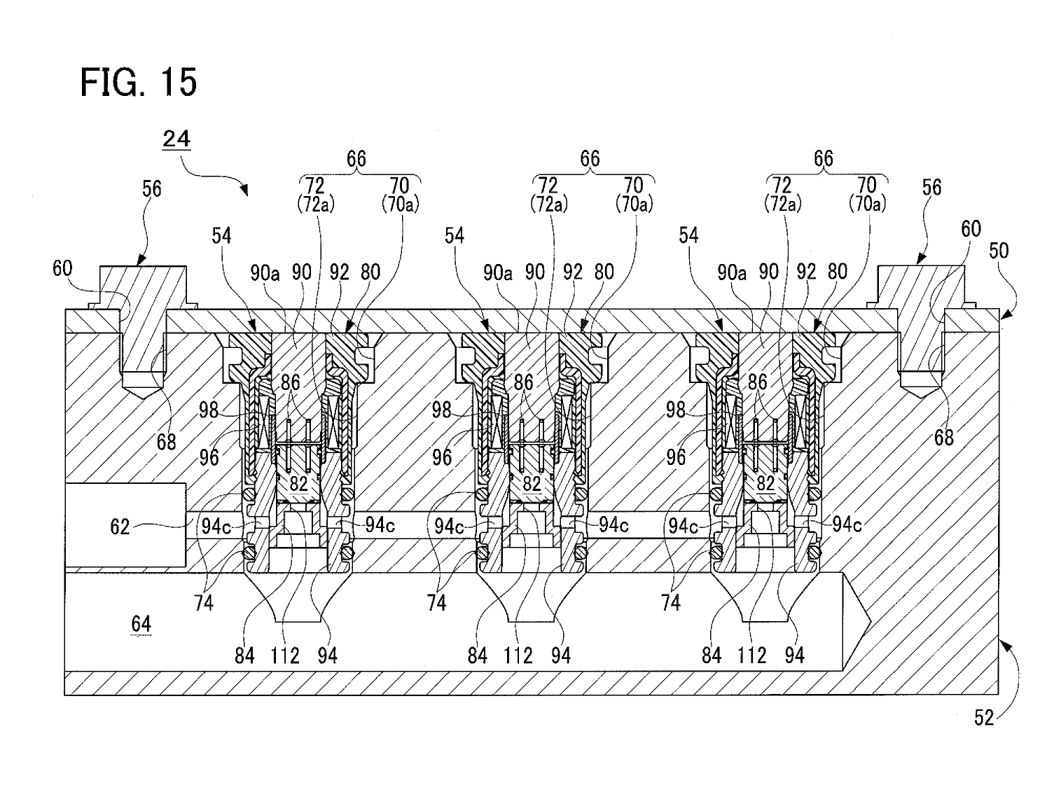

In this example, the injectors 54, except for the connector parts 102, are covered with the block body 52 and the plate 50 as shown in FIGS. 14 and 15. Specifically, the injectors 54 are covered with the plate 50 so that the plate 50 is placed on the upper end faces 90a of the stator cores 90. Since most part of each injector 54 is covered with the block body 52 and the plate 50, sounds (e.g., operation sound, injection sound, etc.) can be shielded from the outside of the hydrogen supply unit 24. Thus, noise can also be reduced.

The foregoing examples are mere examples that do not limit the invention. The invention may be embodied in other specific forms without departing from the essential characteristics thereof. For instance, the fuel supply unit of the invention can also be applied to a unit for supplying fuel gas such as natural gas.

### EXPLANATION OF REFERENCE SIGNS

1 Fuel cell system
10 Fuel cell
12 Hydrogen cylinder
14 Hydrogen supply passage
24 hydrogen supply unit
50 Plate
52 Block body
54 Injector
62 Inflow passage
64 Outflow passage
66 Fitting hole
70 Large-diameter portion
72 Fitting portion
74 O-ring
80 Main unit
82 Valve element
82a Upper end face
82b Lower end face
82c Outer peripheral surface
84 Valve seat
84a Seat surface
84b Outer peripheral surface
86 Compression spring
88 Casing body
90 Stator core
90a Upper end face
90b Lower end face
92 Housing
94 Casing
94a Through hole
94b Inner peripheral surface
94c Communication hole
102 Connector part
104 Seat sealing member
104a Contact portion
112 Injection port
114 O-ring
116 Space part
118 Atmosphere open passage
120 Cutout portion
122 Enclosed space part
124 O-ring space part
P Fuel pressure
Lv Central axis (of Valve element)

What is claimed is:

1. A fuel supply unit comprising:
a plurality of side-feed injectors each having a side surface formed with a communication port through which fuel is supplied into the corresponding injector; and
a block body provided with an inflow passage in which the fuel flows, an outflow passage through which the fuel injected from the injectors flows out, and a plurality of fitting holes which are connected to the inflow passage and the outflow passage and in which the respective injectors are fitted,
wherein the fitting holes and the injectors are arranged in series in a direction of a central axis of the inflow passage, and
wherein the inflow passage is connected to the fitting holes from a radial direction of the fitting holes.

2. The fuel supply unit according to claim 1, wherein the injectors are held by the block body and a single cover member.

3. The fuel supply unit according to claim 2, wherein the cover member has a plate shape and is fastened to the block body with a fastening member.

4. The fuel supply unit according to claim 2,
wherein each of the injectors is provided with a connector part connectable with an external power source, and
wherein the injectors, except for the connector parts, are covered with the block body and the cover member.

5. The fuel supply unit according to claim 1, wherein the inflow passage is one passage formed from outside of the block body to extend across the fitting holes.

6. The fuel supply unit according to claim 1, wherein the outflow passage is one passage formed from outside of the block body to extend across the fitting holes.

7. The fuel supply unit according to claim 1,
wherein each of the injectors includes:
a valve element, a valve seat which the valve element makes contact with or separates from;
a stator core placed in a position opposite from the valve seat with respect to the valve element;
a casing body accommodating the valve element, the valve seat, and the stator core; and
an urging member placed between the valve element and the stator core, and
wherein the valve element is urged by the urging member in a direction toward the valve seat.

8. The fuel supply unit according to claim 7, wherein the valve element and the stator core are formed with no passage for the fuel.

9. The fuel supply unit according to claim 7,
wherein each of the injectors includes an enclosed space part hermetically defined by the valve element, the stator core, and the casing body, and
wherein one of gas, liquid, and an elastic member is provided in the enclosed space part.

10. The fuel supply unit according to claim 7,
wherein each of the injectors includes a space part defined by the valve element, the stator core, and the casing body, and
wherein the stator core is provided with a communication passage communicating with the space part and outside of the injector.

11. The fuel supply unit according to claim 7, wherein the stator core is provided with a countersink part or a hollow part.

12. The fuel supply unit according to claim 7, wherein each of the injectors is provided with a sealing member placed between an outer peripheral surface of the valve element and an inner peripheral surface of the casing body.

13. The fuel supply unit according to claim 12,
wherein each of the valve elements includes a seat sealing member placed on a surface on a side close to the valve seat,
wherein the seat sealing member includes a contact portion which makes contact with the valve seat during valve closing in which the valve element is held in contact with the valve seat,
wherein each of the sealing member and the contact portion has an annular shape centered at a central axis of the valve element, and
wherein a diameter of the contact portion is smaller than a diameter of the sealing member.

14. The fuel supply unit according to claim 12,
wherein the sealing member includes two O-rings, and
wherein the O-rings are arranged to generate an O-ring space part between the O-rings, and a material to enhance sliding property of the valve element with respect to the inner peripheral surface of the casing body is enclosed.
